(19) United States
(12) Patent Application Publication
(10) Pub. No.: US 2008/0096564 A1
(43) Pub. Date: Apr. 24, 2008

(54) Apparatus and methof for determining handover time in broadband wireless communication system

(75) Inventors: Jin-Kwan Jung, Seoul (KR); Jang-Hoon Yang, Seongnam-si (KR)

Correspondence Address: DOCKET CLERK, P.O. DRAWER 800889, DALLAS, TX, 75380, US

(73) Assignee: SAMSUNG ELECTRONICS Co., LTD., Suwon-city (KR)

(21) Appl. No.: 11/975,057

(22) Filed: Oct. 16, 2007

(30) Foreign Application Priority Data
Oct. 20, 2006 (KR) 2006-0102362

(51) Int. Cl. H04Q 7/20

(52) U.S. Cl. 455/436

(57) ABSTRACT

The present invention relates to a handover in a broadband wireless communication system. In the broadband wireless communication system, a mobile station includes: a measuring unit for measuring a strength of a signal received from a serving Base Station (BS) or a neighboring BS; a determining unit for determining a scanning time period according to the strength of the signal received from the serving BS; and a scanning unit for scanning neighboring BSs after the determined scanning time period is over.

### CROSS-REFERENCE TO RELATED APPLICATION(S) AND CLAIM OF PRIORITY

The present application claims priority under 35 U.S.C. §119 to an application filed in the Korean Intellectual Property Office on Oct. 20, 2006 and assigned Serial No. 2006-0102362, the contents of which are herein incorporated by reference.

### TECHNICAL FIELD OF THE INVENTION

The present application relates generally to a broadband wireless communication system, and in particular, to an apparatus and method for determining a handover time by a Mobile Station (MS) in a broadband wireless communication system.

### BACKGROUND OF THE INVENTION

A Mobile Station (MS) in a cellular-based wireless communication system has to perform a handover so as to continuously receive a service while moving from one cell to another. To perform the handover, the MS measures a Carrier to Interference and Noise Ratio (CINR) by performing a scanning process. When a serving Base Station (BS) and a neighboring BS use the same frequency band, the scanning process can be performed without an additional signaling operation. On the other hand, when the serving BS and the neighboring BS use different frequency bands from each other, the MS performs a signaling operation of the scanning process for the serving BS, and a time period for performing the scanning process has to be assigned to the MS. However, during the scanning process, the serving BS may be disconnected in the time period for the scanning process.

FIG. 1 illustrates a signal flow diagram when an MS determines a handover time in a broadband wireless communication system according to the prior art.

Referring to FIG. 1, an MS 110 checks whether a CINR of a signal received from a serving BS 120 is below a reference value (step 101).

Next, the MS 110 transmits a scanning request message to the serving BS 120 (step 103). The scanning request message includes information on the number of frames (N frames) required in a scanning process.

Upon receiving the scanning request message from the MS 110, the serving BS 120 transmits a scanning response message to the MS 110 (step 105). The scanning response message includes information on a scanning start frame (after M frames elapse) and information on the number of frames (N frames) allocated for the scanning process.

Upon receiving the scanning response message from the serving BS 120, the MS 110 is disconnected from the serving BS 120 after the M frames elapse, obtains synchronization with the neighboring BS 130 during the N-frame time period, and measures a CINR of the neighboring BS 130 (step 107).

If a handover requirement is satisfied after performing the scanning process, that is, the CINR of the neighboring BS 130 is greater than that of the serving BS 120, the MS 110 performs a handover to the neighboring BS 130. Otherwise, the MS 110 re-transmits the scanning request message to the serving BS 120 after the scanning time period is over.

FIG. 2 is a graph illustrating a scanning time and a handover time of an MS in a broadband wireless communication system according to the prior art.

Referring to FIG. 2, when a scanning time period is set to T, the scanning process is performed eight times until a handover is performed, after the CINR of a serving BS decreases below a scanning reference value. As a result, communication is disconnected eight times.

On the other hand, when the scanning time period is set to 2T, the scanning process is performed five times until the handover is performed, after the CINR of the serving BS decreases below the scanning reference value. In this case, although the number of times of performing the scanning process is reduced than when the scanning time period is set to T, there is a problem in that the handover cannot be performed at an exact time.

As such, in the broadband wireless communication system, communication is disconnected when the scanning process is repeatedly performed to handover to the neighboring BS that uses a different frequency band. Furthermore, when the scanning time period increases to reduce the number of times of performing the scanning process, the handover cannot be performed at an exact time. That is, when the handover is performed to the neighboring BS that uses a different frequency band, since the scanning time period is used without alteration once it is set, there has been a problem in that a handover time cannot be properly determined or communication is frequently disconnected due to frequent scanning.

### SUMMARY OF THE INVENTION

To address the above-discussed deficiencies of the prior art, it is a primary object to provide an apparatus and method for determining a handover time in a broadband wireless communication system.

The present invention also provides an apparatus and method for reducing a communication disconnection time in a scanning process when a handover is performed in a broadband wireless communication system.

The present invention also provides an apparatus and method for adaptively modifying a scanning time period according to a strength of a signal received from a serving Base Station (BS) when a handover is performed in a broadband wireless communication system.

According to one aspect of the present invention, there is provided a mobile station apparatus in a broadband wireless communication system, comprising: a measuring unit for measuring a strength of a signal received from a serving BS or a neighboring BS; a determining unit for determining a scanning time period according to the strength of the signal received from the serving BS; and a scanning unit for scanning neighboring BSs after the determined scanning time period is over.

According to another aspect of the present invention, there is provided a method of determining a handover time of a mobile station in a broadband wireless communication system, comprising the steps of: measuring a strength of a signal received from a serving BS or a neighboring BS; determining a scanning time period according to the strength of the signal received from the serving BS; and scanning neighboring BSs after the determined scanning time period is over.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description when taken in conjunction with the accompanying drawings, in which like reference numerals represent like parts:

FIG. 1 illustrates a signal flow diagram when a Mobile Station (MS) determines a handover time in a broadband wireless communication system according to the prior art;

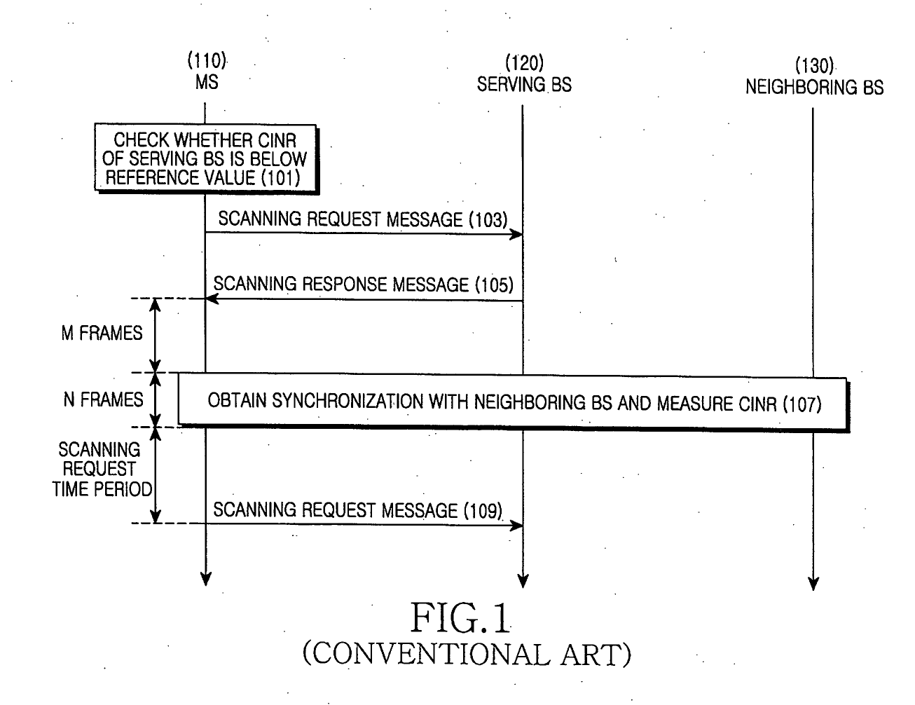

FIG. 2 is a graph illustrating a scanning time and a handover time of an MS in a broadband wireless communication system according to the prior art;

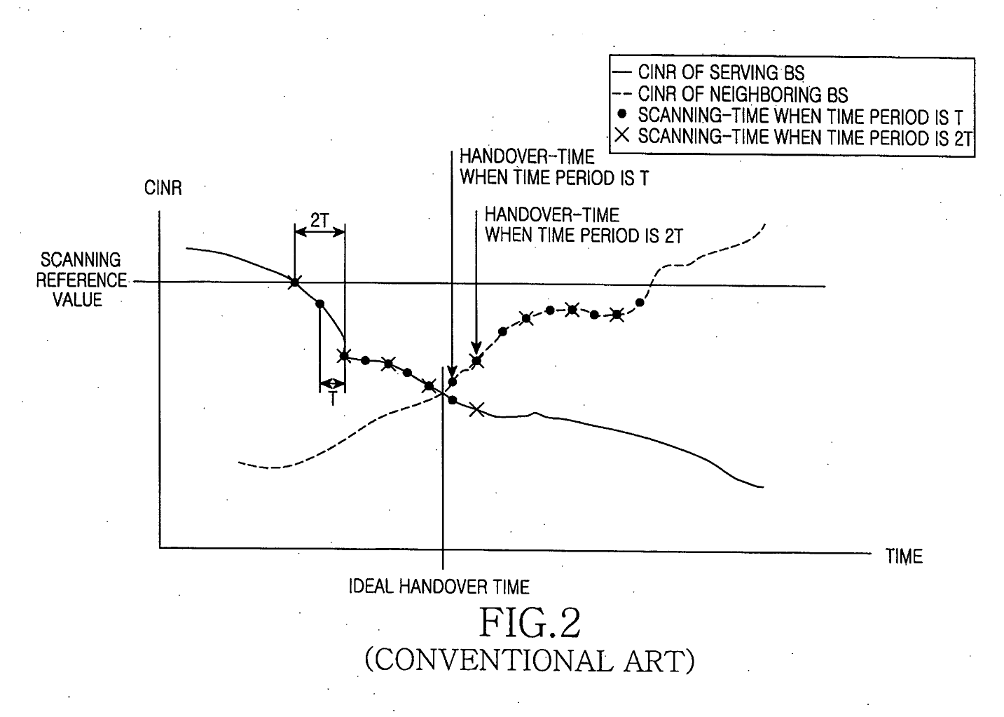

FIG. 3 is a block diagram of an MS in a broadband wires communication system according to the present invention;

FIG. 4 is a flowchart illustrating a process in which an MS determines a handover time in a broadband wireless communication system according to the present invention; and

FIG. 5 is a graph illustrating a scanning time and a handover time of an MS in a broadband wireless communication system according to the present invention.

### DETAILED DESCRIPTION OF THE INVENTION

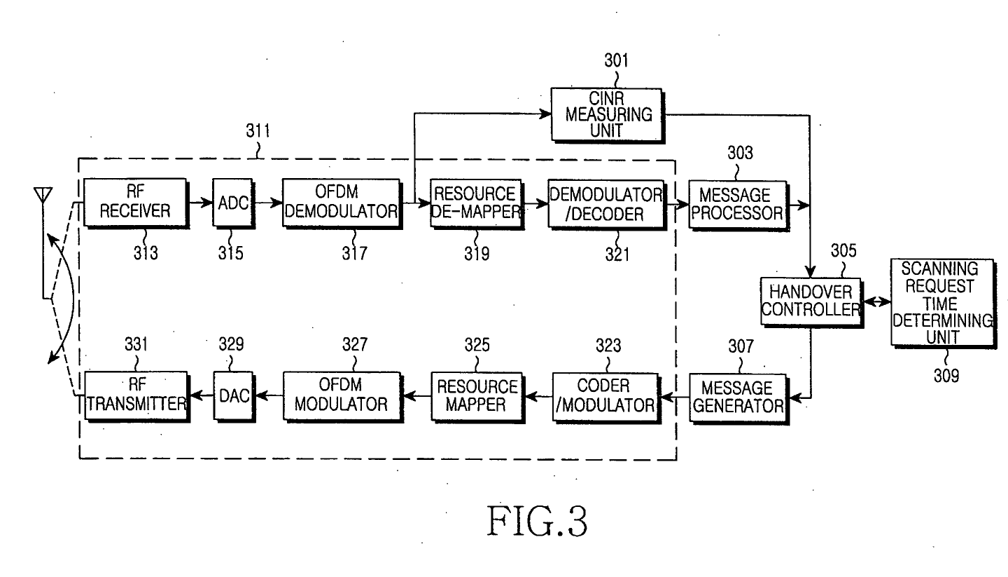

FIGS. 3 through 5, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication system.

A preferred embodiment of the present invention will be described herein below with reference to the accompanying drawings. In the following description, well-known functions or constructions are not described in detail since they would obscure the invention in unnecessary detail.

Hereinafter, a technique will be described in which signals of neighboring Base Stations (BSs) are scanned to determine a handover time in a broadband wireless communication system. In the following descriptions, the wireless communication system is an Orthogonal Frequency Division Multiplexing (OFDM) system. However, this is by way of example only. The present invention may also be easily applied to other types of wireless communication systems.

FIG. 3 is a block diagram of a Mobile Station (MS) in a broadband wires communication system according to the present invention.

Referring to FIG. 3, the MS includes a Carrier to Interference and Noise Ratio (CINR) measuring unit 301, a message processor 303, a handover controller 305, a message generator 307, a scanning request time determining unit 309, and a wireless communication unit 311.

The CINR measuring unit 301 measures a CINR using a preamble signal of a serving Base Station (BS) or a neighboring BS. The measured CINR is provided to the handover controller 305 and the scanning request time determining unit 309.

The message processor 303 analyzes a message received from the BSs. For example, when a scanning response message is received from the BS, the message processor 303 checks information on a scanning start time and information on a scanning performing time, each of which information is included in the received message.

The handover controller 305 determines whether to perform a handover by using CINR information provided from the CINR measuring unit 301, and performs the handover. Although not shown, the handover controller 305 includes a scanning unit. The scanning unit obtains synchronization with the neighboring BS that uses a different frequency band and compares an average CINR of the neighboring BS with an average CINR of the serving BS. In addition, although not shown, the handover controller 305 further includes a handover unit. If the average CINR of the neighboring BS is greater than that of the serving BS, the handover unit performs a handover.

The message generator 307 generates a control message to be transmitted to the BSs, and outputs the control message to the wireless communication unit 311. For example, the message generator 307 generates a scanning request message for checking the CINR of the neighboring BS that uses the different frequency band.

The scanning request time determining unit 309 receives the CINR of the serving BS from the CINR measuring unit 301, and regulates a scanning time period in an adaptive manner according to the CINR of the serving BS. In other words, if the scanning process needs to be performed again because a handover requirement is not satisfied after scanning neighboring BSs, the scanning request time determining unit 309 determines a scanning time period for the request of re-scanning. For example, the scanning request time determining unit 309 may determine the scanning time period as shown in Table 1 below in which the CINR of the serving BS is divided into several levels, and the scanning time period is determined according to each level.

TABLE 1

| | scanning |
|---|---|
| CINR range of serving BS | time period |
| first reference value > CINR ≧ second reference value | T₁ |
| second reference > CINR ≧ third reference value | T₂ |
| third reference value > CINR | T₃ |

In Table 1, T₁, T₂, and T₃ denote scanning request standby time periods determined according to the CINR, where first reference signal>second reference signal>third reference signal and T₁>T₂>T₃.

The wireless communication unit 311 includes a radio frequency (RF) receiver 313, an analog-to-digital converter (ADC) 315, an OFDM demodulator 317, a resource de-mapper 319, a demodulator/decoder 321, a coder/modulator 323, a resource mapper 325, an OFDM modulator 327, a digital-to-analog converter (DAC) 329, and an RF transmitter 331.

The RF receiver 313 converts an RF signal received through an antenna into a baseband signal. The ADC 315 converts an analog signal provided from the RF receiver 313 into a digital signal. The OFDM demodulator 317 converts a time-domain signal provided from the ADC 315 into a frequency-domain signal through a Fast Fourier Transform (FFT) operation. The resource de-mapper 319 extracts data which is mapped to the frequency domain, when the data is provided from the OFDM demodulator 317 and corresponds to an allocated resource. The demodulator/decoder 321 demodulates and decodes the data provided from the resource de-mapper 319 by using a predetermined method.

The coder/modulator 323 converts the data using a predetermined method. The resource mapper 325 maps the data provided from the coder/modulator 323 to a sub-carrier resource. The OFDM modulator 327 converts the frequency-domain signal, which has been mapped to a frequency resource by the resource mapper 325, into a time-domain signal through an Inverse Fast Fourier Transform (IFFT) operation. The DAC 329 converts a digital signal provided from the OFDM modulator 327 into an analog signal. The RF transmitter 331 converts a baseband signal provided from the DAC 329 into an RF signal, and then transmits the RF signal through the antenna.

In the aforementioned structure, the handover controller 305 may perform functions of the scanning request time determining unit 309. Although the two elements 305 and 309 are distinctively depicted in the figure, this is for description purposes only. Thus, in practice, the functions of the scanning request time determining unit 309 may be wholly or partially performed by the handover controller 305.

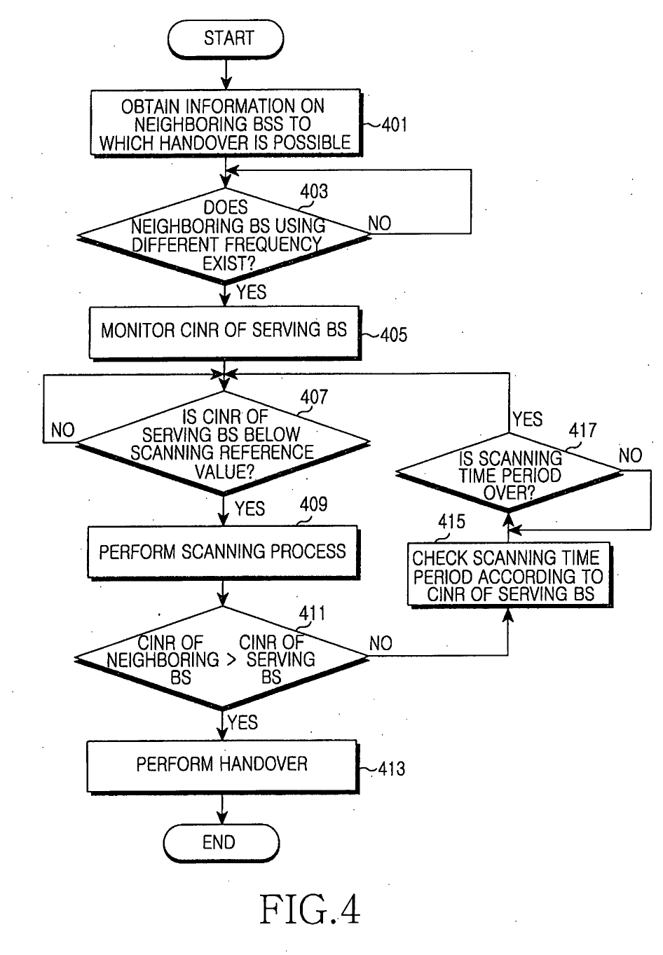

FIG. 4 is a flowchart illustrating a process in which a mobile station (MS) determines a handover time in a broadband wireless communication system according to the present invention.

Referring to FIG. 4, in step 401, information on neighboring BSs to which a handover is possible is obtained from a serving BS.

Upon obtaining the information on the neighboring BSs, in step 403, the neighboring BSs to which a handover is possible are checked to detect a neighboring BS that uses a frequency band different from that of the serving BS.

In step 405, a CINR of the serving BS is continuously monitored.

In step 407, it is checked whether the CINR of the serving BS decreases below a scanning reference value.

If the CINR of the serving BS decrease below the reference value, in step 409, a scanning process is performed. That is, a signaling operation of the scanning process is performed for the serving BS, and thereafter the MS is disconnected from the serving BS. Then, the MS obtains synchronization with the neighboring BS, and measures a CINR of the neighboring BS.

After performing the scanning process, in step 411, the CINR of the neighboring BS is compared with the CINR of the serving BS. Herein, the CINR is obtained by averaging a plurality of CINRs for a predetermined time period.

If the CINR of the neighboring BS is greater than the CINR of the serving BS, that is, if a handover requirement is satisfied, in step 413, a handover is performed to the neighboring BS.

Otherwise, if the handover requirement is not satisfied, the procedure goes to step 415 to determine a scanning time period according to the CINR of the serving BS.

After determining the scanning time period, in step 417, it is checked whether the determined scanning time period is over.

If the scanning time period is over, the procedure returns to step 407 to check whether the CINR of the serving BS is below the scanning reference value.

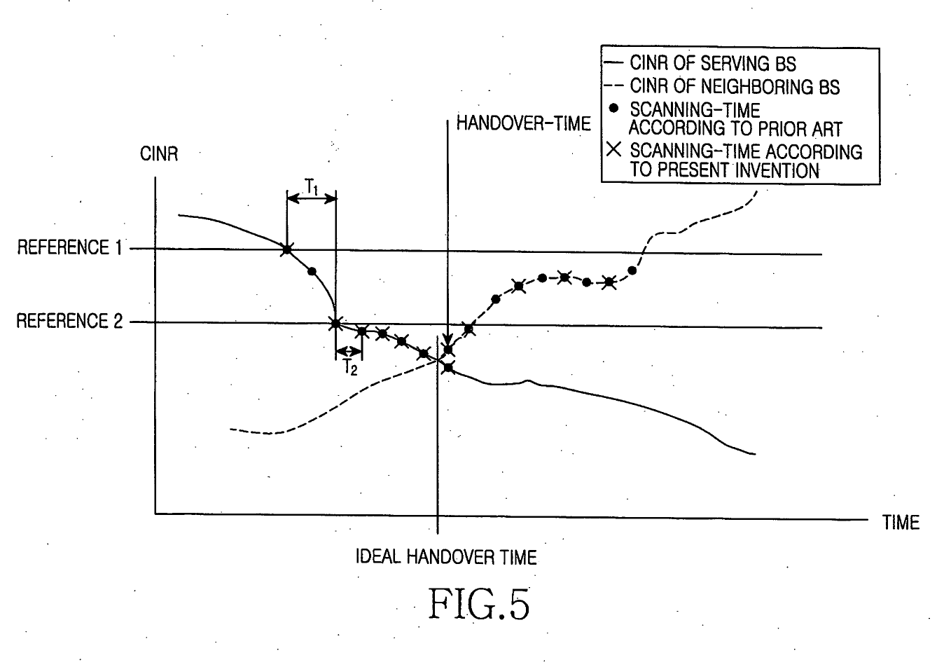

FIG. 5 is a graph illustrating a scanning time and a handover time of an MS in a broadband wireless communication system according to the present invention. In FIG. 5, a CINR of a serving BS is divided into two levels such that a scanning time period of one level is twice that of the other level.

Referring to FIG. 5, if the CINR of the serving BS decreases below a first reference value, the MS scans neighboring BSs. That is, the MS transmits a scanning request message to the serving BS, receives a scanning response message, obtains synchronization with a neighboring BS, and measures a CINR. Herein, when the CINR is between the first reference value and the second reference value, the scanning time period is set to T₁, before the scanning process is performed.

If the CINR decreases below the second reference value, the MS modifies the scanning time period to T₂ and then performs the scanning process. When the time period T₂ is set to the scanning time period, it is possible to perform a handover at a relatively proper time in comparison with the conventional method. That is, the number of times of performing the scanning process is less than the conventional method, and a handover time is similar to the conventional method.

The MS measures the CINR using a signal received from the BS, and the CINR is used as a reference for determining a handover. The CINR is only an example for representing a strength of a received signal. Thus, besides the CINR, either an SNR or an SINR, or combination of the two may be used to represent the strength of the received signal.

According to the present invention, a scanning time period is adaptively regulated according to a CINR of a serving base station (BS) in a broadband wireless communication system. Therefore, a handover can be performed at an exact time while reducing the number of times of communication disconnection in the process of scanning.

Although the present disclosure has been described with an exemplary embodiment, various changes and modifications may be suggested to one skilled in the art. It is intended that the present disclosure encompass such changes and modifications as fall within the scope of the appended claims. Therefore, the scope of the invention is defined not by the detailed description of the invention but by the appended claims, and all differences within the scope will be construed as being included in the present invention.

What is claimed is:

1. A mobile station apparatus in a broadband wireless communication system, comprising:
a measuring unit for measuring a strength of a signal received from a serving Base Station (BS) or a neighboring BS;
a determining unit for determining a scanning time period according to the strength of the signal received from the serving BS; and
a scanning unit for scanning neighboring BSs after the determined scanning time period is over.

2. The apparatus of claim 1, wherein the determining unit determines the time period so that the greater the strength of the signal received from the serving BS, the longer the time period.

3. The apparatus of claim 1, wherein the strength of the received signal includes at least one item selected from a group consisting of a Carrier to Interference and Noise Ratio (CINR), a Signal to Noise Ratio (SNR), and a Signal to Interference and Noise Ratio (SINR).

4. The apparatus of claim 1, wherein, after the scanning time period is over, the scanning unit performs a scanning process if the strength of the signal received from the serving BS is below a threshold.

5. The apparatus of claim 1, wherein the scanning unit obtains synchronization with the neighboring BS, and compares an average strength of a signal received from the neighboring BS with an average strength of a signal received from the serving BS.

6. The apparatus of claim 1, wherein the serving BS and the neighboring BS use different frequency bands from each other.

7. A method of determining a handover time of a mobile station in a broadband wireless communication system, comprising the steps of:
measuring a strength of a signal received from a serving Base Station (BS) or a neighboring BS;
determining a scanning time period according to the strength of the signal received from the serving BS; and
scanning neighboring BSs after the determined scanning time period is over.

8. The method of claim 7, wherein the scanning time period is determined so that the greater the strength of the signal received from the serving BS, the longer the time period.

9. The method of claim 7, wherein the strength of the received signal includes at least one item selected from a group consisting of a Carrier to Interference and Noise Ratio (CINR), a Signal to Noise Ratio (SNR), and a Signal to Interference and Noise Ratio (SINR).

10. The method of claim 7, further comprising:
after the scanning time period is over, checking whether a strength of a signal received from the serving BS is below a threshold; and
if the strength of the received signal is below the threshold, performing a scanning process.

11. The method of claim 7, wherein, the step of performing the scanning process includes obtaining synchronization of the neighboring BS and comparing an average strength of a signal received from the neighboring BS with an average strength of a signal received from the serving BS.

12. The method of claim 7, wherein the serving BS and the neighboring BS use different frequency bands from each other.

13. For use in a wireless communication system comprising a plurality of base stations, a mobile station capable of performing a handoff operation from a first one of the plurality of base stations to a second one of the plurality of base stations, wherein the mobile station is operable to: i) determine a strength of a first signal received from the first base station, ii) determine a scanning time period according to the strength of the received first signal, and iii) scan at least one neighboring base station of the plurality of base stations after the determined scanning time period is over.

14. The mobile station of claim 13, wherein the scanning time period is determined so that the greater the strength of the received first signal, the greater the scanning time period.

15. The mobile station of claim 13, wherein the strength of the received first signal is determined from a Carrier to Interference and Noise Ratio (CINR) value associated with the received first signal.

16. The mobile station of claim 13, wherein the strength of the received first signal is determined from a Signal to Noise Ratio (SNR) associated with the received first signal.

17. The mobile station of claim 13, wherein the strength of the received first signal is determined from a Signal to Interference and Noise Ratio (SINR) associated with the received first signal.

18. The mobile station of claim 13, wherein the mobile station is further operable to determine whether the strength of the received first signal is below a reference value and, if the strength of the received first signal is below the reference value, to scan the at least one neighboring base station.

19. The mobile station of claim 13, wherein the mobile station obtains synchronization of a second base station and compares a strength of a signal received from the second base station with the strength of the received first signal.

20. The mobile station of claim 13, wherein the first and second base stations use different frequency bands from each other.
